(19) United States
(12) Patent Application Publication
(10) Pub. No.: US 2026/0075450 A1
(43) Pub. Date: Mar. 12, 2026

(54) DETERMINING AND REPORTING OF SPARSITY INFORMATION FOR A DOWNLINK REFERENCE SIGNAL

(71) Applicant: InterDigital Patent Holdings, Inc., Wilmington, DE (US)

(72) Inventors: Afshin Haghighat, Ile-Bizard (CA); Roozbeh Mohammadian, Outremont (CA); Loic Canonne-Velasquez, Dorval (CA); Mohammad Irfan, Chateauguay (CA); Moon IL Lee, Melville, NY (US); Omid Saatlou, Montreal (CA); Jonghyun Park, Syosset, NY (US)

(73) Assignee: InterDigital Patent Holdings, Inc., Wilmington, DE (US)

(21) Appl. No.: 18/828,750

(22) Filed: Sep. 9, 2024

(51) Int. Cl. H04W 24/10; H04W 72/232

(52) U.S. Cl. CPC H04W 24/10; H04W 72/232

(57) ABSTRACT

A wireless transmit/receive unit (WTRU) may receive first configuration information. The first configuration information may indicate a first downlink reference signal (RS) and/or parameters comprising information indicating a minimum channel impulse response (CIR) duration, a maximum CIR duration, an amplitude threshold, frequency-domain patterns, and/or time-domain patterns. The WTRU may receive downlink control information (DCI). The DCI may comprise triggering information that directs the WTRU to perform measurements and/or report a sparsity order of a channel associated with the downlink RS. The WTRU may determine the sparsity order of the channel associated with the downlink RS may be based on the parameters. The WTRU may send a report that comprises an indication of the sparsity order, an indication of a preferred frequency-domain pattern indicating RSs according to the sparsity order, and/or spatial information associated with the sparsity order.

### BACKGROUND

Compressive sensing is a method for efficient processing of a signal according to its inherent statistical behavior. For example, by relying on a set of basis vectors, compressive sensing may allow sampling of a signal at a lower sampling frequency than the Nyquist rate. As such, the regeneration of the series may be realized through the information available by a few samples (e.g., coefficients).

The general concept of compressive sensing relies on the sparsity of the target signal, so that a small set of samples (e.g., coefficients) may be used for reproduction of the original signal by scaling and/or summation of the basis vectors. Sparsity-ness of a series may be characterized by the ratio of the number of dominant coefficients to the number of coefficients with a negligible power. In its simplest form, counting the number of non-zero coefficients may determine the sparsity order of a series.

### SUMMARY

A wireless transmit/receive unit (WTRU) may receive first configuration information. The first configuration information may indicate a first downlink reference signal (RS). The first configuration information may indicate one or more parameters. The one or more parameters may comprise information indicating a minimum channel impulse response (CIR) duration, a maximum CIR duration, an amplitude threshold, one or more frequency-domain patterns, and/or one or more time-domain patterns. The WTRU may receive downlink control information (DCI). The DCI may comprise triggering information that directs the WTRU to perform measurements and/or report a sparsity order of a channel associated with the downlink RS. The WTRU may determine the sparsity order of the channel associated with the downlink RS based on the one or more parameters. The WTRU may send a report that comprises one or more of an indication of the sparsity order, an indication of a preferred frequency-domain pattern indicating RSs according to the sparsity order, and/or spatial information associated with the sparsity order.

The WTRU may determine the sparsity order as an estimate of a number of non-zero CIR coefficients associated with the first downlink RS within a predefined time duration.

The WTRU may determine the sparsity order based on a subset of delay paths, wherein the subset of delay paths is within the minimum CIR duration and/or the maximum CIR duration. The subset of delay paths may exceed the amplitude threshold.

The parameters may comprise one or more frequency-domain patterns and/or time-domain patterns. Each frequency-domain pattern and/or time-domain pattern may be associated with a different sparsity order.

The report may further comprise information indicating a time-domain pattern. The report may indicate a delay profile of the channel and/or comprises a bitmap associated with the time-domain pattern. The bitmap may comprise one or more bits of a first value that are associated with a CIR coefficient that has met a preconfigured threshold.

The indication for the preferred frequency-domain pattern may further comprise a location of each resource element and/or subcarrier that carries the first downlink RS.

The indication for the preferred frequency-domain pattern may be based on a bitmap and/or an index to one or more other frequency-domain patterns.

The DCI may indicate one or more uplink resources, and/or the processor is configured to send the report via the uplink resources identified by the DCI.

The WTRU may receive second configuration information. The second configuration information may indicate a second downlink RS. The second downlink RS may be based on the sparsity order. The WTRU may receive one or more of an indication for a frequency-domain pattern for second downlink RS placement and/or a rotation parameter of the frequency-domain pattern. The WTRU may determine a frequency-domain pattern for the second downlink RS based on one or more of the indications for frequency-domain pattern for second downlink RS placement and/or the rotation parameter of the frequency-domain pattern.

The indication for a frequency-domain pattern for second downlink RS placement may comprise a bitmap. The bitmap may have a length equal to or less than the maximum number of possible RS locations.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts charts for compressible/sparse and non-compressible/non-sparse vectors and/or signals.

FIG. 3 depicts charts for 4×4 multiple input/multiple output (MIMO) performance with and without compressive sensing (CS)-based pilot for cluster delay line A (CDL-A) and CDL-E channel models.

FIG. 4 depicts a flowchart for a detailed procedure for CS-based channel estimation in orthogonal frequency division multiplexing (OFDM) systems.

FIG. 5 depicts a flowchart for a functional presentation of sparsity-based reference signal (RS) design.

FIG. 6 depicts a RS optimization based on the determined channel sparsity.

FIG. 7 depicts an illustration of N frequency-domain resource patterns, each with M resource blocks (RBs).

FIG. 8 depicts a diagram of a wireless transmit/receive unit (WTRU) that reports a channel state information (CSI) associated to a sparsity order.

### DETAILED DESCRIPTION

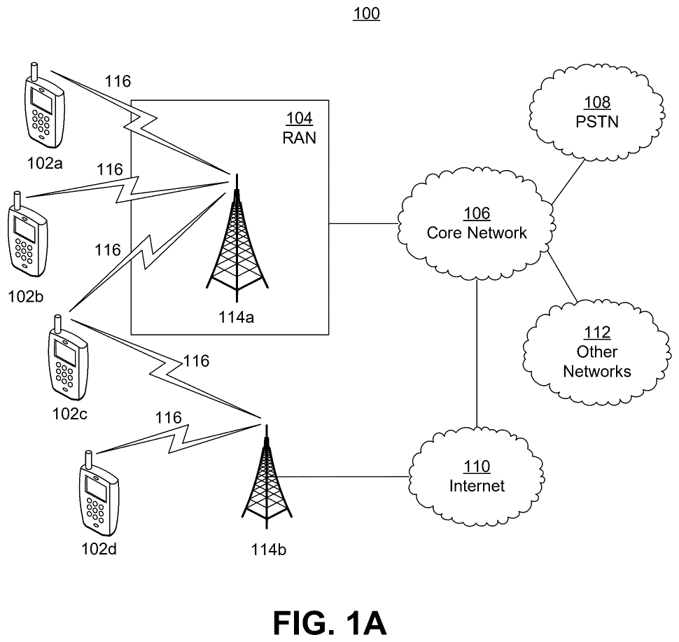

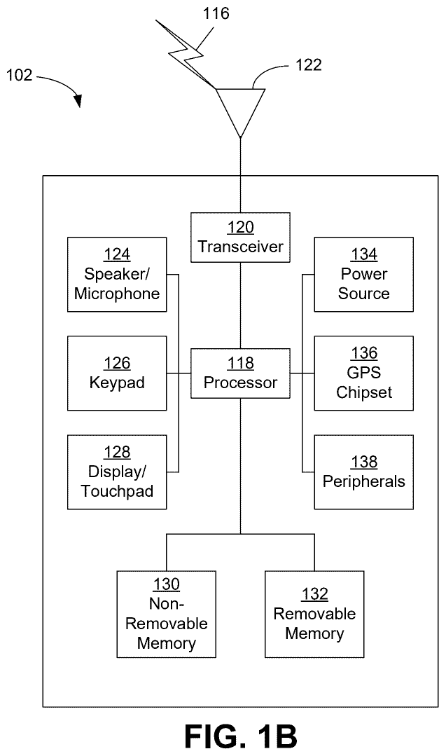

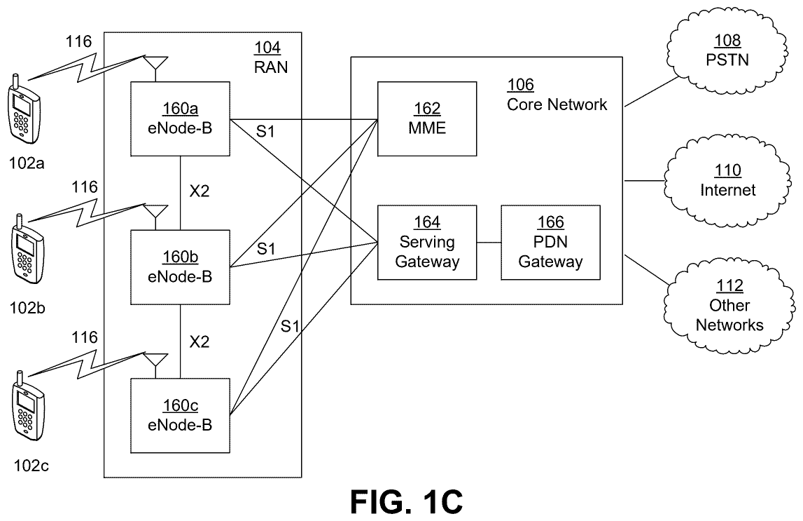

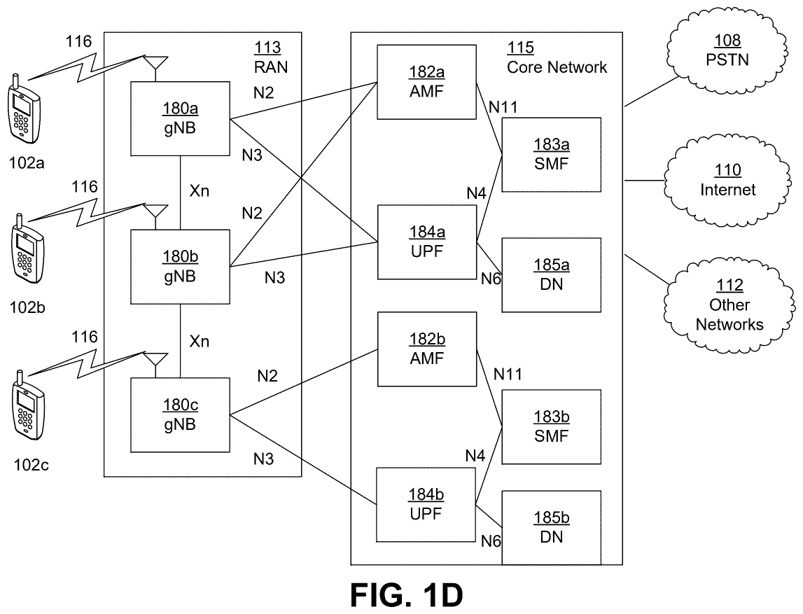

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Disclosed herein are methods and/or procedures associated with the determination and/or reporting of sparsity information for a downlink (DL) reference signal (RS). Selected features may include new radio (NR) multiple input multiple output (MIMO). Selected procedures and/or functions may include RS determination and/or configuration. Further disclosed are methods and/or procedures for sparsity measurement, detection, and/or reporting are.

Channel estimation is a key step in wireless communication systems. To achieve reliable estimation of wireless communication channels, commonly high-density RSs may be used. RSs have been designed to support various operations of the system, for example, channel sounding for estimating the channel state information (CSI). While the existing systems have some degrees of flexibility in selection of the RS pattern, the patterns may not often match channel behavior closely. In other words, to facilitate the applicability of RSs to all types of wireless channels, current RSs may be designed with high density in the frequency-domain. Although generalization of the existing RSs to estimation of all channels is desirable, the existing RSs' high density may burden large overhead on communication systems adversely affecting the spectral efficiency (SE) of the communications systems. One solution for preserving the quality of channel sounding with lower RSs overhead may include utilizing the sparse/compressible structure of wireless channels. In examples, wireless channels may be represented by only a small number of parameters. The channels in such cases are called sparse/compressible.

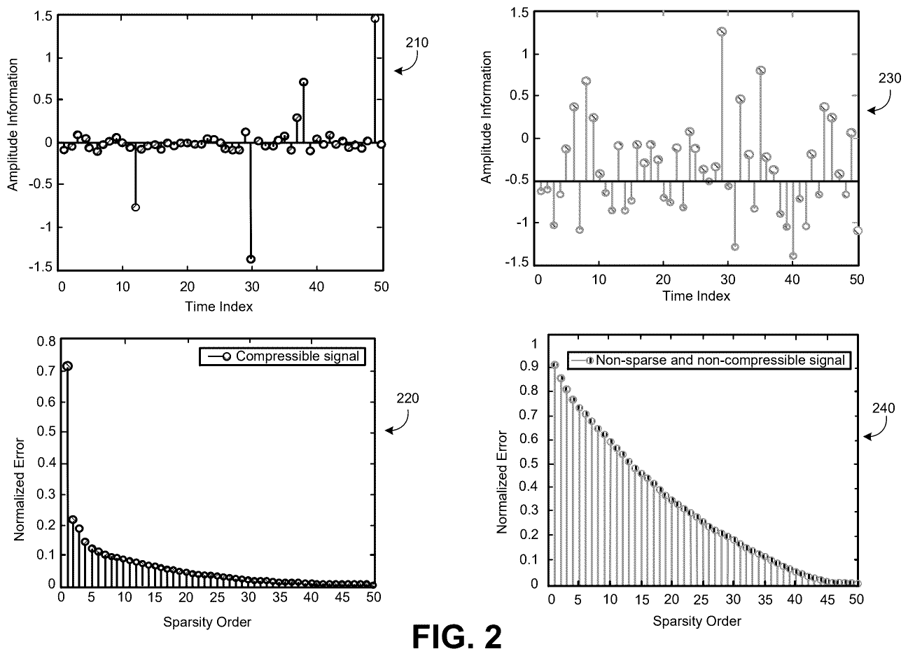

Mathematically, h_{L×1} is called a s-sparse vector/signal if it has at most s non-zero elements where s<<L. Accordingly, s is referred to as the sparsity order/level of h_{L×1}. Following the sparsity definition, a vector is called compressible if it may be approximated by a sparse vector. Examples of sparse/compressible and/or non-sparse/non-compressible vectors are shown in FIG. 2. FIG. 2 also depicts the normalized sparse approximation errors of the sparse/compressible and/or non-sparse/non-compressible vectors. For a compressible signal 210, the sparse approximation error 220 may fall exponentially as the approximated sparsity order increases. However, for a non-compressible signal 230, the error 240 may decline considerably more slowly.

Sparsity/compressibility of wireless channels may be seen in the time domain (e.g., delay domain), the spatial domain, or both. For instance, in the environments where a few significant scatterers shape the propagation channel, only a limited number of taps of the channel impulse response (CIR) may contain most of the channel energy. Under these conditions, if the time difference between the earliest and the latest multipath components (e.g., effective CIR length) is large compared to the number of significant taps of the CIR, then the wireless channel is called sparse/compressible in the time domain.

Compressive sensing (CS) has revealed that a sparse signal may be recovered and/or reconstructed from its samples with much lower sampling frequency than the conventional Nyquist rate. The standard problem of interest in the CS theory is finding the desired vector h∈ [symbol] ^{L×1} from the following noisy under-determined linear system of equations:

$$y = Φ h + n \qquad ( Equation 1 )$$

under the assumption that h is a s-sparse vector (s<<L), and the number of linear measurements of h, e.g., the number of elements in y∈ [symbol] ^{m×1}, satisfies s<m<<L. In Equation (1), the term n∈ [symbol] ^{m×1} represents the measurement noise. In the context of CS theory, y and Φ are, respectively, referred to as the measurement vector and the measurement matrix. CS theory may demonstrate that under some conditions on the measurement matrix Φ, there exist efficient methods (e.g., orthogonal matching pursuit (OMP)) that may efficiently solve Equation (1) for h if

$$m \approx 𝒪 ( s log \frac{L}{s} ) .$$

According to the CS theory, results achieved for sparse signals may readily be extended to the compressible signals as well. The notion of compressibility is much more important than sparsity, because most of the natural signals are compressible rather than being exactly sparse. Since wireless communication channels may be seen as compressible signals, the results and/or tools introduced by the CS theory apply to estimation of wireless channels resulting in the reduction of RSs overhead and/or improvement of the system SE.

In wireless OFDM systems, the channel estimation problem may be considered as finding h∈ [symbol] ^{L×1}, the CIR with effective length L, from the Equation 2:

$$y = XFh + n \qquad ( Equation 2 )$$

where y∈ [symbol] ^{m×1} comprises the received signals over the subcarriers carrying the RSs, X∈ [symbol] ^{m×m} is a diagonal matrix with RSs over its main diagonal, F^{m×L} is the partial discrete Fourier transform (DFT) matrix, and n∈ [symbol] ^{m×1} represents the additive noise. Comparing Equation (2) with Equation (1) reveals that CIR estimation may be seen as a standard CS problem with Φ [symbol] XF as the measurement matrix. Therefore, a RS design based on the CS theory may adapt the RS and/or pilot pattern to the sparse/compressible wireless channel, and/or avoid over-, or under-transmission of RSs and/or pilots.

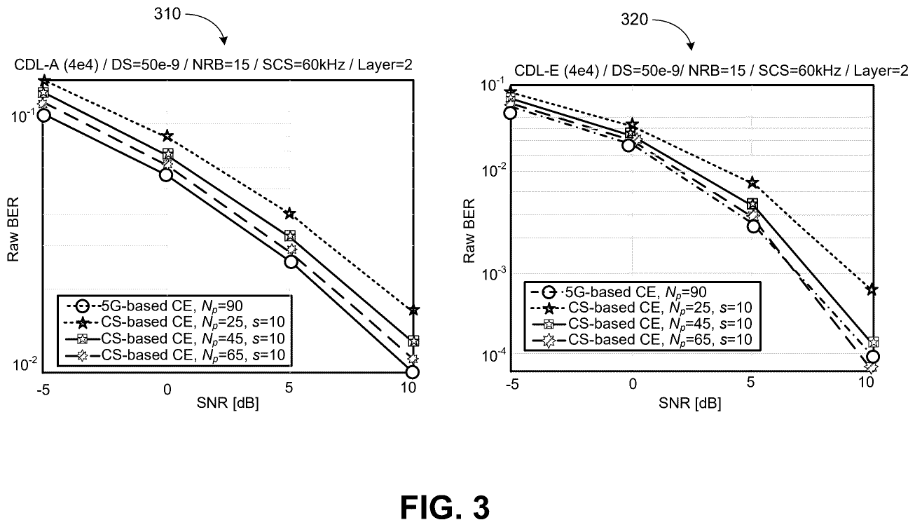

FIG. 3 depicts evaluation results for CS-based channel estimation in an OFDM system. More specifically, FIG. 3 depicts charts for 4×4 multiple input/multiple output (MIMO) performance with and without compressive sensing (CS)-based pilot for cluster delay line A (CDL-A) 310 and CDL-E 320 channel models. The data is plotted on signal-to-noise ratio (SNR) on the horizontal axis (e.g., x-axis) vs. raw bit error rate (BER) on the vertical axis (e.g., y-axis) in the charts 310 and 320. According to the presented results 310 and 320 in FIG. 3, by leveraging on channel sparsity/compressibility, pilot overhead may be significantly reduced. Also, CS-based channel estimation may be used for various channel assumptions (e.g., tapped delay line (TDL), CDL, and/or their variants).

As stated in the CS theory, a small coherence value of the measurement matrix, e.g., Φ in Equation (1), is sufficient to ensure the estimation/reconstruction of sparse/compressible signals using the underdetermined linear system of equations detailed in Equation (1). For a generic matrix Φ the coherence is defined as provided in Equation 3:

$${μ}_{Φ} = {max}_{\begin{matrix}1 \leq i , l \leq L , \\ i \neq l\end{matrix}} \frac{\vert 〈 {φ}_{i} , {φ}_{l} 〉 \vert}{{‖ {φ}_{i} ‖}_{2} {‖ {φ}_{l} ‖}_{2}} \qquad ( Equation 3 )$$

where φᵢ is the i-th column of Φ. Based on the format of the measurement matrix in Equation (2), e.g., Φ=XF, the coherence value of Φ depends on the structure of RSs and/or pilots. Existing RSs patterns (e.g., uniform patterns) used in the practical systems may not design measurement matrices with low coherence values. Therefore, to enable the applicability of CS-based sparse channel estimation in OFDM systems, designing RS patterns that result in measurement matrices with low coherence values is critical.

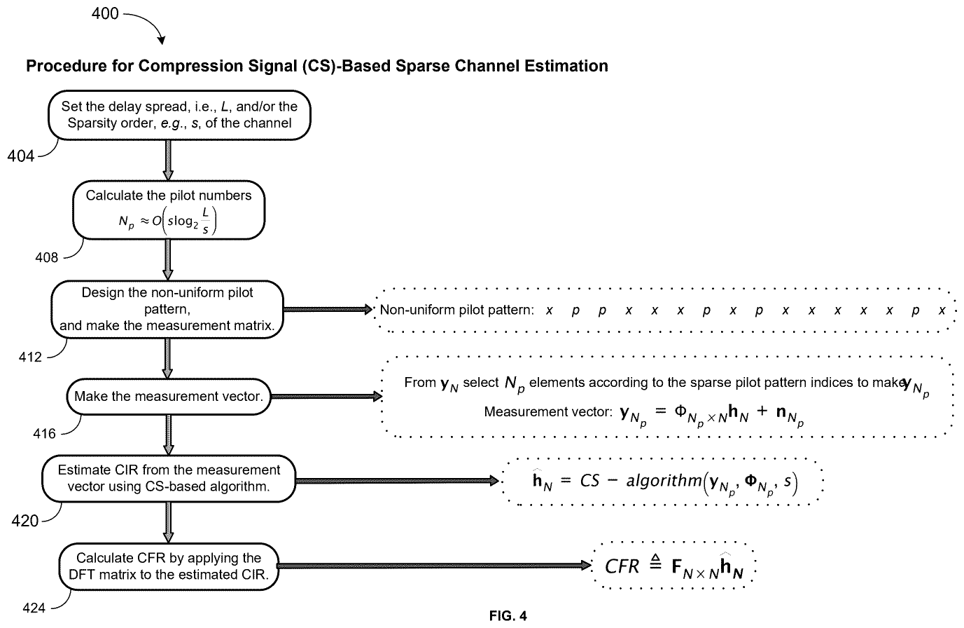

FIG. 4 depicts a flowchart 400 of an exemplary procedure for CS-based channel estimation in OFDM systems. At 404, the effective CIR length, the time difference between the earliest and the latest multipath components, and/or the sparsity order and/or level of the CIR are calculated. At 408, the number of RSs and/or pilots (e.g., the number of subcarriers which carry RSs and/or/pilot) may be determined based on the effective CIR length and/or the sparsity order of the wireless channel. At 412, the non-uniform RS and/or pilot pattern (the index set of subcarriers conveying RSs and/or pilots) may be designed based on minimizing the coherence value. The measurement matrix may be formed using the designed pattern. At 416, by stacking measured values over the subcarriers carrying the RSs and/or pilots, the measurement vector is created. At 420, CIR is estimated from the measurement vector using a CS-based reconstruction algorithm. At 424, channel frequency response (CFR) is calculated by applying the DFT matrix to the estimated CIR.

In current communications systems, RSs may not closely match the characteristics of the transmission channels. Therefore, the density of RS may be either over or under what is required. Herein, aspects related to use of sparsity by compressive sensing for RS design are discussed. In particular, the described solution focuses on enabling determination, reporting, and/or usage of sparsity order that is the key to employing compressive sensing.

While the solution is described for a downlink (DL) scenario, however many components of the presented solutions may equally apply for an uplink (UL) scenario. Besides compressive sensing, the described solutions may also apply to other methods of sparsity-based design of efficient pattern for RSs where the determined pattern is adapted according to the channel characteristics.

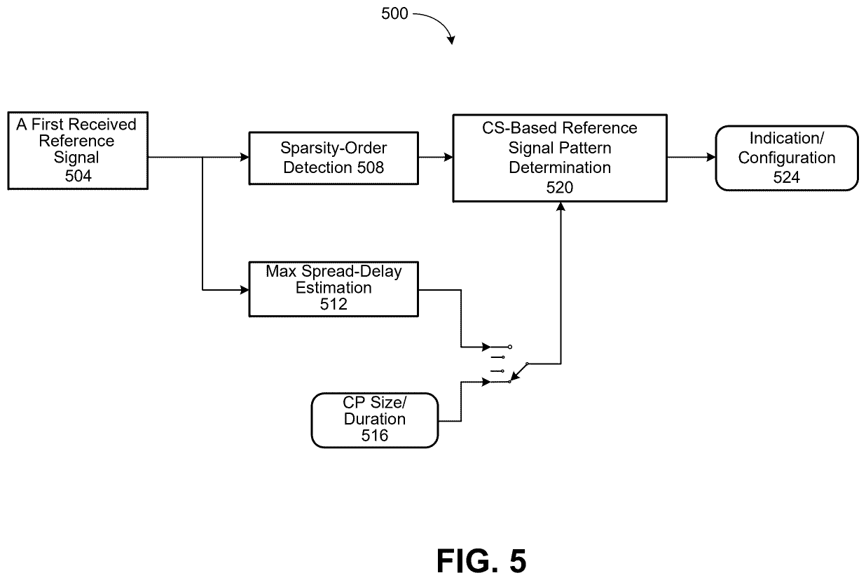

FIG. 5 depicts a flowchart 500 for a functional presentation of sparsity-based RS design. The solution shown in FIG. 5 details the determination and/or reporting of sparsity information for a DL RS. At 504, a WTRU may be configured with a first (e.g., periodic) DL RS (for determination of the sparsity order of the DL channel). The WTRU may be further configured with one or more sets of the following parameters: a minimum/maximum delay spread value for a delay profile (e.g., for determination of the sparsity order); one or more amplitude thresholds for a path to be considered (e.g., a min/max relative amplitude threshold, a min/max differential value between different path amplitudes (for determination of the sparsity order), etc.); a set of one or more (e.g., irregular) frequency-domain and/or time-domain patterns each corresponding to a sparsity order (e.g., a different sparsity order).

The WTRU may receive a DL control information (DCI) to trigger measurement and/or reporting of the sparsity order of the channel associated to the first DL RS.

At 508, the WTRU may determine and/or detect the sparsity order of the channel associated to the first DL RS according to the configured parameters, (e.g., max/min delay, amplitude threshold, etc.) At 512, the determined sparsity order may be an estimate of the number of non-zero channel impulse response coefficients within a predefined time span (e.g., CP duration 516). At 520, according to the configured min/max delay spread value and amplitude threshold values, the WTRU may consider a subset of the delay paths within the configured min/max delay interval and/or meeting the configured amplitude threshold.

The UE may report (e.g., by using UL resources indicated in the triggering DCI) an explicit and/or implicit indication 524 of the determined sparsity order. For example, the WTRU may report explicitly the determined value for the sparsity order. In another example, the WTRU may report a time domain pattern, describing the delay profile of the channel, e.g., a bit-map where each “1” represents a coefficient that has met a configured threshold. The information may also be accompanied by one or more amplitude information per location to indicate (e.g., strength of each coefficient).

The WTRU may report an indication of a preferred frequency-domain pattern indicating pilot locations according to the determined sparsity order (e.g., for a second DL RS). In an example, the indicated frequency-domain pattern may define the location of each RE or subcarrier carrying a RS. For example, the indication may be based on a bit-map and/or an index to one of the configured frequency-domain patterns. The WTRU may also report a spatial information associated to the reported sparsity-order.

Regarding the usage of a determined and/or indicated sparsity order, the WTRU may receive an indication for configuration of a second DL RS (based on a sparsity order). The reported sparsity order and/or an indicated sparsity-order may include an indication for frequency-domain pattern, describing a pattern (e.g., an irregular pattern) for RS placement over the scheduled bandwidth. For example, the reported sparsity order and/or an indicated sparsity-order may include a length N bitmap to span over the scheduled bandwidth where N is the max number of possible RS locations. Moreover, the reported sparsity order and/or an indicated sparsity-order may include a set of indices, each associated with a different configured frequency-domain pattern where the WTRU determines the desired pattern based on the union of the indicated patterns. Further, the reported sparsity order and/or an indicated sparsity-order may include a rotation (shift) parameter of the frequency-domain pattern, defining the rotation of the frequency-domain pattern (e.g., WTRU-specific and/or WTRU group, etc.) For example, a rotation of 2 means that the WTRU may shifts all pilot locations by two REs (e.g., to the right direction).

The WTRU may determine the frequency-domain pattern for the second DL RS based on the received indication (e.g., indicated pattern(s), and/or rotation and/or shift parameters). For example, the WTRU may determine its assigned pilot pattern based on the union of one or more indicated patterns wherein each pattern has an associated rotation and/or shift parameter.

The WTRU may receive and/or measure the second DL RS according to the determined frequency-domain pattern. The WTRU may determine and/or reports CSI based on the received second DL RS.

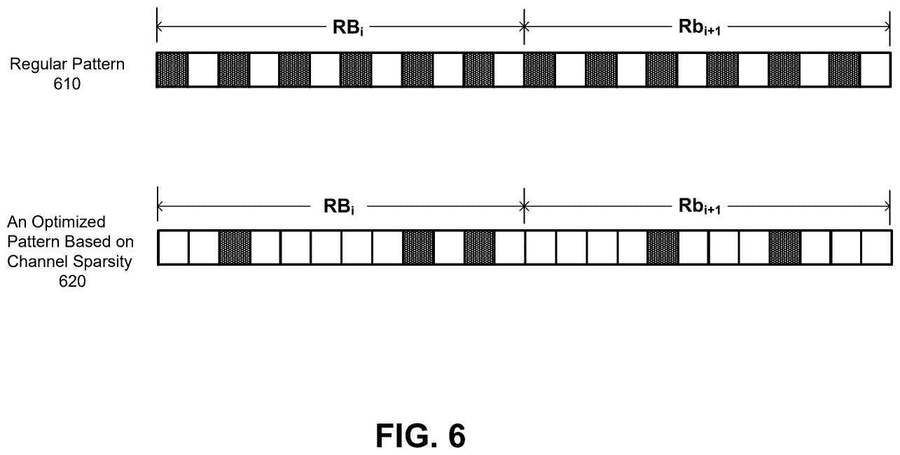

FIG. 6 depicts a RS optimization based on the determined channel sparsity. The upper trace 610 of RBs shows the regular (e.g., conventional) pattern of RS placement across RBs based on a uniform placement. However, the lower trace 620 of RBs shows an irregular pattern. In the lower trace 620, the RS placement is based on sparsity of the channel and there is therefore less RS overhead.

As indicated herein, the term sparsity of a transmission channel may be used in various contexts. The sparsity of the channel may be used for DL as well as UL RS. The sparsity of the channel may be used not only for sounding RSs, such as CSI-RS and/or sounding RS (SRS), but also for demodulation RSs, such as DM-RS for data and/or control. Moreover, the usage is not restricted to single-input single-output (SISO) transmission, but also equally applies to MIMO transmission.

Hereafter, the term “sparsity order” may be interchangeably used with the following terms: sparsity, flatness level, flatness order, compression efficiency level, compression efficiency order, RS pattern, RS frequency-domain pattern, frequency density of the RS, and/or number of dominant coefficients.

For a transmission scenario, to exploit sparsity of the transmission channel, a WTRU may function in different modes. For example, a WTRU may be configured with a first RS for sparsity determination, and/or a default RS pattern for channel sounding and/or demodulation. The WTRU may be configured with multiple configurations of a RS, each corresponding to a different sparsity order. The WTRU may determine the sparsity order and/or determine the RS corresponding to the determined sparsity order.

The WTRU may report the sparsity order. After reporting, and in a DL scenario, the WTRU may assume future transmissions after a time window, (e.g., a configured time window), are based on the determined RS. If the WTRU determines (using blind detection, e.g., based on constellation) that the RS is not transmitted according to the reported sparsity order, the WTRU may fall back to the default RS pattern. In another example involving a DL and/or UL scenario, the WTRU may wait for network (e.g., gNB) confirmation. The confirmation may be a semi-static (e.g., radio resource control (RRC)), or a dynamic indication, (e.g., medium access control (MAC)) and/or a scheduling DCI.

The WTRU may base the determination of sparsity of a channel on the estimated channel impulse response. The estimated CIR may be presented by h=[h₁, h₂, . . . , h_{L}]^{T} where each hᵢ represents a delay path which may also be called a “channel tap.” Prior to performing the determination of the sparsity, a WTRU may perform one or more of the following pre-processing steps, through which the estimated CIR may be filtered: a WTRU may restrict the delay difference between the first and the last path. For example, a WTRU may be configured with a max_first_last_delay value to ignore some of the delay paths (e.g., ignore the last few taps). In another solution, a WTRU may be configured with a resolution_delay value. By using the resolution_delay value, the delay paths that are too close to each other may be grouped as one delay. Any two paths closer than the resolution_delay value may be considered as “too close.” In another example, a WTRU may be configured with a min_amplitude value. The WTRU may drop the delay paths are below that value. Moreover, a WTRU may be configured with a max_to_min ratio, by which, a delay path that results in |hₘₐₓ|/|hᵢ|>max_to_min may be dropped. In another example, a WTRU may cap all the non-zero taps, (e.g., taps that are above a configured min_amplitude value), to unity.

Hereafter, the term “path” may be interchangeably used with the terms: delay path, channel impulse response, channel tap, and/or channel response.

A WTRU may be configured with one or more of several parameters for sparsity order determination, measurement, and/or reporting measured/determined sparsity order. Such parameters may include one or more RS configuration(s) to measure sparsity order. Such parameters may include time window (e.g., length, start and end time, start time, and/or length, etc.) configuration wherein the WTRU may determine sparsity order based on measured channel information. The time window may be implicitly determined based on one or more system parameters (e.g., cyclic prefix length of OFDM symbol, subcarrier spacing, and/or OFDM symbol length). As an example, a scaling factor may determine the time window length. The scaling factor may be multiplied to the CP length used for a current DL transmission (or CP length determined for the RS used for sparsity order determination). The time window may be explicitly indicated based on a reference point (e.g., a first path)

Parameters may also relate to determine dominant path (e.g., threshold for amplitude, minimum time gap between two paths to be considered as a separate path, etc.). Herein, the term “path” may be referred to as resolvable path, the number of resolvable path in a given time window may be different based on system bandwidth, communication bandwidth, and/or RS bandwidth, etc.

Moreover, parameters for sparsity order determination, measurement, and/or reporting measured/determined sparsity order may include compression level. The compression level may determine an association between sparsity order and preferred RS density, and/or pattern, etc. For example, for a given sparsity order, the associated RS density and/or pattern may be determined based on the indicated compression level. The compression level may be referred to as a subset of RS density/pattern.

As the first step for determining the sparsity order, a WTRU may estimate the DL CIR based on receiving a configured RS. Then, the WTRU may measure the sparsity order of the DL channel, noted as s, using any method for sparsity order estimation. Based on one or more performed measurements, the WTRU may determine the sparsity order, s. In a solution, a WTRU may declare the sparsity s of a channel, if the measured sparsity satisfies s≤sₜₕ; where sₜₕ is a configured threshold. Otherwise, the WTRU may declare that the DL channel is not sparse.

Based on the estimated CIR, which may be presented by h=[h₁, h₂, . . . , h_{L}]^{T}, a WTRU may use one or more different solutions for determination and/or reporting of, s, the sparsity order of the channel. In such a solution, a WTRU may determine the sparsity of the channel based on computing one or more of its CIR norms. For example, a WTRU may indicate the sparsity order of the estimated channel h, through one or more of the following steps: the WTRU may calculate the CIR's l₁ norm, i.e.,

$${l}_{1} = {\sum }_{i = 1}^{L} \vert {h}_{i} \vert .$$

Then the WTRU may compute the CIR's l₂ norm, i.e.,

$${l}_{2} = \sqrt{{\sum }_{i = 1}^{L} {\vert {h}_{i} \vert}^{2}} .$$

Then WTRU may evaluate the quantity sₗ, defined as

$${s}_{l} {=}^{Δ} {( \frac{{l}_{1}}{{l}_{2}} )}^{2} .$$

Then, the WTRU may determine the sparsity order as s=f(sₗ), where f(sₗ)=┌sₗ┐, or f(sₗ)=┌sₗ┐, etc. The WTRU may report one of the computed norm values, e.g., l₂, as l₁ may be derived from reported RSRP, etc.

As another example, a WTRU may determine the sparsity order of the DL CIR according to one or more of the following steps: the WTRU may calculates the CIR's l₁ norm. The WTRU may compute the CIR's l_{q} norm, i.e.,

$${l}_{q} = {( {\sum }_{i = 1}^{L} \vert {h}_{i} \vert )}^{\frac{1}{q}} ,$$

where q∈(0,1)∪(1, +∞) is the configuration parameter. The WTRU may evaluate the quantity s_{q}, defined as

$${s}_{q} {=}^{Δ} {( \frac{{l}_{q}}{{l}_{1}} )}^{\frac{q}{1 - q}} .$$

The WTRU may determine the sparsity order of the DL channel as s=f(s_{q}), where f(s_{q})=┌s_{q}┐, or f(s_{q})=┌s_{q}┐, etc. In a solution, a WTRU may report one of the computed norm values, e.g., l_{q}, as l₁ may be derived from reported RSRP, etc.

In another solution, a WTRU may determine the sparsity order based on the amplitude and/or power of each channel path, e.g., γᵢ=|hᵢ| or γᵢ=|hᵢ|² that may be captured by tap amplitudes in the estimated CIR according to one or more of the following steps: the WTRU may compute the amplitude of each tap, γᵢ. If the amplitude of the tap, γ, meets a threshold, (e.g., the amplitude of the tap, γ, is greater than a configured threshold γ≥γₜₕₑ), the WTRU may consider the path as a significant path. Otherwise, the path is ignored. The WTRU may determine sparsity order, s, as the number of significant taps.

In another solution, WTRU may determine the sparsity order as the number of CIR's taps that contain a significant percentage of the total CIR energy. Herein, the WTRU may estimate the sparsity order through one or more procedures: in the first step, the WTRU may calculates the total CIR's energy as

$$p = {\sum }_{i = 1}^{L} {\vert {h}_{i} \vert}^{2} .$$

In the second step, the WTRU may find the smallest K that results in the ratio

$$\frac{{p}_{K}}{p}$$

to meet a threshold, (e.g., to exceed a threshold), where pₖ is the computed sum energy based on the K most significant taps. The WTRU may report that one of the computed norm values, e.g., l₂, as l₁ may be derived from reference signal receive power (RSRP), etc.

In another example, the WTRU may determine the sparsity order of the channel with one or more of the following steps: in the first step, the WTRU may calculate

$$𝒥 {=}^{Δ} {\sum }_{i = 1}^{L} tanh ( a {\vert {h}_{i} \vert}^{b} )$$

where a>0 and b>1 are the configured values. These configured values may be selected based on statistical behavior of the channel. In the next step, the WTRU may determine the sparsity order as s=f( [symbol] ), where f( [symbol] )=┌ [symbol] ┐, or f( [symbol] )=└ [symbol] ┘, etc.

In another example, the WTRU may determine and/or report the sparsity order based on one or more of the following steps: in the first step, the WTRU may compute the measure

$$ℒ {=}^{Δ} {\sum }_{i = 1}^{L} {log}_{10} ( 1 + {\vert {h}_{i} \vert}^{2} ) .$$

In the second step, the WTRU may determine the sparsity order as s=f( [symbol] ), where f( [symbol] )=┌ [symbol] ┐, or f( [symbol] )=└ [symbol] ┘, etc.

In another solution, the WTRU may determine and/or report the sparsity order of the DL CIR based on a mixture of different sparsity order measures. In an example, WTRU may indicate the sparsity order of the estimated channel h, through one or more of the following steps: the WTRU may calculate the CIR's l₁ norm. The WTRU may compute the CIR's l_{q} norm, where q∈(0,1)∪(1, +∞) is the configuration parameter. The WTRU may evaluate the quantity s_{q}. The WTRU may calculate the measure [symbol] . The WTRU may calculate the sparsity order of the DL CIR as s=f(s_{q}, [symbol] ), where f(s_{q}, [symbol] )=┌wₛ_{_{q}} s_{q}┐+┌ [symbol] ┐, or f(s_{q}, [symbol] )=└wₛ_{_{q}} s_{q}┘+┌ [symbol] [symbol] , etc.; where wₛ_{_{q}} and [symbol] are the configuration parameters.

In another example, the WTRU may indicate the sparsity order of h according to one or more of the following steps: the WTRU may compute the measure [symbol] . The WTRU may calculate the quantity [symbol] . The WTRU may evaluate the value of s_{q}. The WTRU may indicate the sparsity order of the DL CIR as s=f( [symbol] ), where f( [symbol] )=┌ [symbol] ┐, Or f( [symbol] )=└ [symbol] ┘, etc., where [symbol] and wₛ_{_{q}} are the configuration parameters.

A WTRU may determine and/or report one or more sparsity order for a DL MIMO channel H, with N_{T} and N_{R} transmit and/or receive antennas, where there are N_{T}N_{R} subchannels, hᵢⱼ, i:1→N_{T}, j:1→N_{R}, a. In an example, a WTRU may determine and/or report a single sparsity order for the entire MIMO channel, where the determined sparsity order may be based on one or more of a function of determined sparsity orders per channel, i.e., s=f(sᵢⱼ), where M_{T}≤N_{T}, M_{R}≤N_{R}, i∈{1=>M_{T}}, and j∈{1→MR}. For example, the maximum or minimum of the determined sparsity order among the determined sparsity orders, sᵢⱼ, may be based on sub-channel hᵢⱼ, e.g.,

$$s = {max / min}_{\begin{matrix}i : 1 \to {M}_{T} \\ j : 1 \to {M}_{R}\end{matrix}} ( {s}_{ij} ) ,$$

where M_{T}≤N_{T}, M_{R}≤N_{R}. The determined sparsity order may be based on a specific feature of a subchannel, (e.g., the strength of the sub-channel). For example, a WTRU may select and/or report the sparsity order of the strongest sub-channel, hᵢⱼ, as the sparsity order of a MIMO channel.

In another solution, a WTRU may determine and/or report more than one sparsity order, where the number of reported sparsity orders may be based on one or more of the following: according to the number of MIMO subchannels, for example, a WTRU may determine and/or report one sparsity order per subchannel. In a solution, a WTRU may report a subset of the determined sparsity orders, (e.g., reporting a max and a min detected sparsity order). Based on the number of spatial beams, panels, transmit/receive points (TRP), and/or SRS resource sets, etc. The WTRU may determine and/or report one sparsity order per panel, SRS resource port group, and/or SRS resource set, etc. A WTRU may perform sparsity order determination on more than one spatial direction and/or report only spatial directions that their corresponding sparsity order meets a preconfigured threshold.

In an example, the WTRU may be configured with β_{RX} beams for selection and reporting of K<β_{RX} beams. Then, WTRU may perform the following: determination of the sparsity order for all the configured β_{RX} beams; determination of the K beam directions associated with the lowest sparsity order; and/or reporting the K beams.

In another example, besides β_{RX}, a signal strength threshold (e.g., SNRₜₕ) and/or a sparsity order threshold (e.g., sₜₕ) are configured. Then, the WTRU may perform the following to select and/or report the K beam direction based on a signal strength, (e.g., the signal to noise ratio (SNR)) and/or the sparsity order of the beam: determination of K out of β_{RX} beams that their corresponding strength is higher the configured threshold; determination of a sparsity order for the identified K strongest beam directions; and/or reporting the K beams, where the report may include the corresponding sparsity for each beam. For example, a WTRU may be triggered to perform measurement and report two beams out of four configured beams. The WTRU may be configured with at least two thresholds: a first threshold for signal strength (e.g., RSRP) and a second threshold for max value of the sparsity order. The WTRU may perform measurement on each beam to estimate the strength and sparsity order. The WTRU may report one or more beams that have a higher strength than the threshold and/or a max sparsity (e.g., of 4). The WTRU may estimate and/or report one sparsity order for a one layer transmission hypothesis corresponding to the number of transmission layers per detected rank.

The WTRU may receive a DCI to trigger resource(s) for measurement and/or reporting of a report quantity. This report quantity may represent a measure of the scattered and/or distributed amplitude gain(s) and/or propagation delay property of the wireless channel, broadly known as the sparsity of the wireless channel(s) or sparsity order of the wireless channel. This report quantity may be based on measurements performed by the WTRU upon reception of the first DL RS. The sparsity determination, measurement, and/or calculation may be a measure of the sparsity order of the wireless channel and/or a determined, recommended, optimal, and/or best pattern of the RS(s) and/or pilot symbol(s) for channel estimation. The DCI field triggering the first RS may be based on an existing field, e.g., the existing CSI request field in DCI or a new field, e.g., a sparsity request.

In a solution, the WTRU may determine, calculate, measure, and/or estimate the sparsity of the wireless channel based on one or more of the following: a configured, indicated, and/or fixed number of non-zero channel response coefficients, channel impulse response, channel gain, or channel amplitudes within a pre-defined time span (e.g., within a cyclic prefix (CP) duration). The sparsity of the wireless channel may be based on a configured, indicated, and/or fixed threshold, where the threshold may be used to classify one or more of the channel response coefficients, channel impulse response, channel gain or channel amplitudes associated with a propagation path and/or delayed path as a zero coefficient and/or non-zero coefficient. For example, a configured, indicated, and/or fixed threshold for a certain delay path or propagation path is 0.4 and the actual, measured, calculated, and/or estimated channel coefficient, channel gain or channel amplitude associated with the propagation path is 0.5. The WTRU may assume, consider, treat, and/or process, the coefficient associated with the propagation path as a non-zero coefficient when determining sparsity of the wireless channel.

The sparsity of the wireless channel may be based on the power delay profile of the wireless channel, where the power delay profile of the wireless channel may be measured, determined, and/or calculated using the first RS and/or an alternative RS, (e.g., DMRS, and/or TRS).

The sparsity of the wireless channel may be based on the configured, indicated, and/or fixed maximum and/or minimum delay spread, propagation delay, delayed paths, and/or delay intervals. For example, a configured, indicated, and/or fixed delay spread and/or propagation delay for a certain delay path and/or propagation path is 0.3 milliseconds (ms) and the actual, measured, calculated, and/or estimated delay spread and/or propagation delay is 0.4 ms. Since the delay spread or propagation delay of the propagation path is higher than the so-called 0.3 ms threshold, a signal propagating through such a propagation path may experience a higher path-loss. Therefore, the contribution of the propagation path in terms of the total received power is limited. A channel coefficient associated with such a propagation path may be treated as a zero-coefficient when calculating and/or determining sparsity of the channel.

In another example, a configured, indicated, and/or fixed delay spread or propagation delay for a certain delay path or propagation path is 0.3 ms and the actual, measured, calculated, or estimated delay spread or propagation delay is 0.2 ms. Since the delay spread and/or propagation delay of the propagation path is less than the so-called 0.3 ms threshold, a signal propagating through such a propagation path may experience a smaller path-loss. Therefore, the contribution of the propagation path in terms of the total received power transfer may be noticeable and/or higher. Therefore, a channel coefficient associated with such a propagation path may be treated as a non-zero coefficient when calculating or determining sparsity of the channel.

In another example, when the time difference between at least a pair of delayed paths meets a threshold (e.g., the time difference is smaller than a configured, indicated, and/or fixed time value), the two paths may be considered as one from the perspective of sparsity order determination. Additionally or alternatively, when the time difference between at least a pair of delayed paths meets a threshold (e.g., the time difference is larger than a configured, indicated, or fixed time value), the two paths may be considered as independent paths from the perspective of sparsity order determination.

A WTRU may determine, measure, and/or estimate sparsity of the wireless channel (e.g., based on measurement of a RS configured and/or used for sparsity measurement). The sparsity order of the wireless channel and/or the time and/or frequency-domain resources locations or patterns (e.g., the time and/or frequency resource indices, the resource elements (RE) indices, the symbol and/or subcarriers indices, and/or the resource block indices) for transmission of a RS, (e.g., for transmission of the DMRS and/or CSI-RS).

In a solution, a WTRU may be semi-statically and/or dynamically configured (e.g., by RRC, MAC control element (MAC-CE), and/or DCI) on a set of sparsity value(s), and the WTRU may determine, select, and/or pick a sparsity order from the configured list, configured set(s), and/or a fixed set of sparsity value(s). For example, a WTRU may be configured on set S=[0, 1, 2, . . . , 10]. A WTRU may pick and/or select one of the entries from the set S, as a representation of the sparsity order of the wireless channel.

In another solution, a WTRU may be semi-statically and/or dynamically configured (e.g., by RRC, MAC-CE, and/or DCI) on a set or list of time and/or frequency-domain resource locations and/or patterns. The WTRU may determine, select, and/or pick from the pre-defined and/or configured list of resource patterns and/or from a fixed list of time and/or frequency-domain resources pattern.

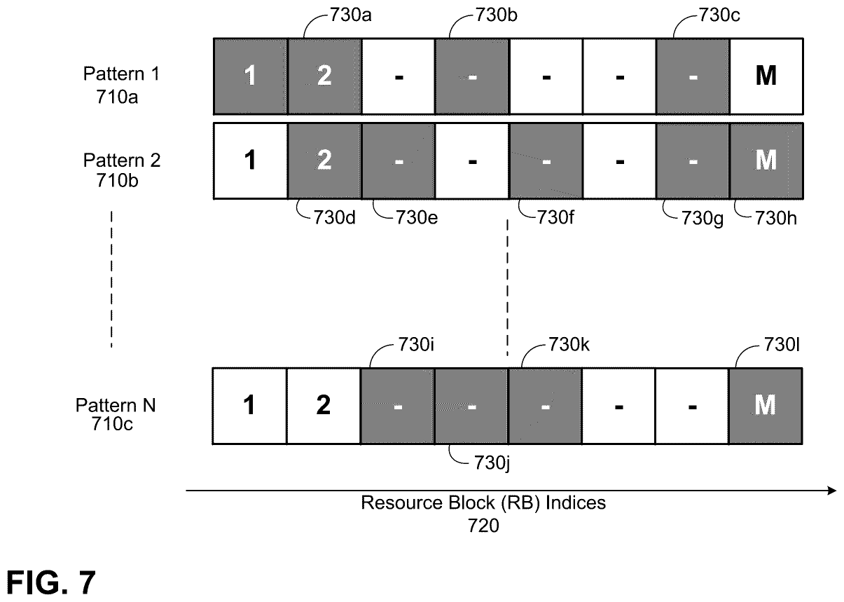

FIG. 7 depicts a set 700 of frequency-domain resource patterns, e.g., a set of N patterns 710a-c where each pattern has M number of frequency-domain resources 720 (e.g., resource blocks (RBs)). The WTRU may pick, select, and/or determine a pattern index out of the available N patterns 710a-c based on measurements performed upon reception of the first RS. The shaded RBs 730a-l in each pattern may indicate the frequency-domain locations for transmission of DMRS and/or CSI-RS or another RS.

In another solution, the WTRU may freely select the sparsity order of the wireless channel and the time and/or frequency-domain pattern, based on the configured number of time and/or frequency-domain resources. The WTRU may be expected to estimate the wireless channel over these time and/or frequency resources and/or over which the WTRU may be expected to receive DL data transmission, (e.g., physical DL shared channel (PDSCH)). For example, the sparsity order of the wireless channel ranges from zero to the total configured number of resource elements (RE). There may be a total number of M configured REs. The number of frequency-domain patterns may range from zero to 2^{M}, where 2^{M} denotes the total number of frequency-domain patterns in terms of the available or configured M number of REs. In examples, the sparsity order of the wireless channel may range from zero to the total configured number of sub-carriers, denoted as c. The number of frequency-domain patterns may range from zero to 2^{c}, where 2^{c} denotes the total number of frequency-domain patterns in terms of the available and/or configured c number of sub-carriers.

Also disclosed herein are indicators designed for sparsity reporting. A WTRU may send an indicator in a CSI report to indicate the sparsity order of the wireless channel and/or the time and/or frequency-domain resource pattern. The WTRU may use at least one of several indicators for indicating the sparsity of the channel and the time and/or frequency-domain resource pattern. In a solution, the WTRU may use a bitmap with a bit-width equal to the number of the configured frequency-domain resources, e.g., equal in numbers to the number of RBs, sub-bands, and/or sub-carriers. For example, the WTRU may be configured with five REs. The WTRU may send a bitmap with bit-width of five bits, e.g., bitmap=[10110], where the “1s” in the bitmap indicate RE indices to be used for transmission of the DMRS and/or CSI-RS. The bitmap [10110] may indicate to use the first, third, and fourth REs for transmission of the DMRS and/or CSI-RS. In an alternative example, the bitmap may indicate the indices of the first, third, and fourth REs for transmission of the DMRS and/or CSI-RS.

In another solution, the number of “1s” in the bitmap to indicate indices of the selected REs may be treated, considered, and/or assumed as an implicit reporting of the sparsity order of the wireless channel. For example, the WTRU may be configured with six REs. The WTRU may send a bitmap [111001] to indicate indices of the REs for transmission of the DMRS and/or CSI-RS. The number of “1s” equal to 4 in the considered example may be treated, considered, and/or assumed as an implicit indication of the sparsity order of the wireless channel.

In another example, the number of “0s” in the bitmap may be treated, assumed, and/or considered as an implicit indication of the sparsity order of the wireless channel when indices of “0s” in the bitmap may be used as RE indices reporting.

The WTRU may use a combinatorial bitmap to indicate the sparsity of the channel and/or the time and/or frequency-domain resource pattern, where the bit-width of the bitmap equal

$$⌈ {log}_{2} ( \begin{matrix}M \\ {N}_{p}\end{matrix} ) ⌉ , ( \begin{matrix}M \\ {N}_{p}\end{matrix} ) = \frac{M !}{{N}_{p} ! ( M - {N}_{p} ) !} ,$$

where (!) is the mathematical factorial operator, Nₚ is the number of selected RBs, and/or Nₚ is reported using ┌log₂ M┐ number of bits. The WTRU may send a first indicator in a CSI report to indicate Nₚ using ┌log₂ M┐ number of bits and/or a second indicator to indicate the indices of the Nₚ selected or determined RBs.

Based on the number of configured frequency-domain resources (e.g., based on the value of M) and/or based on the determined sparsity order (Nₚ) of the wireless channel, the overhead of reporting the sparsity of the wireless channel may grow linearly or exponentially. The growth of the overhead of reporting the sparsity may be further based on the type of the indicator being used. Hereinafter, a method to reduce the sparsity reporting overhead is proposed. In New Radio (NR), the network (e.g., gNB) may configure the frequency-domain resources in the form of sub-bands, where each sub-band may have 4, 8, 16, or 32 RBs. When 10 sub-bands, each with 32 RBs, are configured, the feedback overhead of reporting the frequency-domain pattern may equal 320 bits.

A number of solutions exist to reduce this overhead. For example, the WTRU may report the sparsity as follows: the WTRU may send a first indicator in a CSI report. The first indicator may be based on a bitmap with a bit-width equal to the configured number of sub-bands. For example, the WTRU may send a bitmap with a bit-width equal to 10 bits, e.g., [1011000001]. Each bit in the bitmap may indicates the index of a sub-band. A bit-state (e.g., “1” or “0”) may indicate if the one or more of the 32 RBs in the sub-band has been included or excluded in the frequency-domain pattern. For example, the first indicator, e.g., [1011000001] may indicate that the first, third, fourth, and tenth sub-bands has one or more associated RBs included in the frequency-domain pattern. In another example, the WTRU may send a bitmap with a bit-width equal to 10 bits, e.g., [0100111110]. Each bit in the bitmap may indicate the index of a sub-band. A bit-state, (e.g., “1” or “0”) may indicate if the one or more of the 32 RBs in the sub-band has been included or excluded in the frequency-domain pattern. For example, the first indicator, e.g., [0100111110] may indicate that the first, third, fourth, and tenth sub-bands has one or more associated RBs included in the frequency-domain pattern.

The WTRU may send a second indicator in a CSI report, where the bit-width of the second indicator may depend on the number of RBs in each sub-band and on the number of “1s” in the first indicator. Alternatively, the bit-width of the second indicator may depend on the number “0s” when “0s” indicate a sub-band that includes one or more RBs selected in the frequency pattern in the first indicator. For example, the second indicator may have Qg number of bits, where Q is the number of “1s” (or alternatively “0s” when “0s” are used to indicate a sub-band that includes one or more RBs selected in the frequency pattern) and/or g is the number of RBs in each sub-band.

Each bit in the second indicator may indicate the state (selected or not selected in the frequency-domain pattern) of an RB. Herein, the RB may be associated with a sub-band indicated using the first indicator. For example, the considered first indicator [1011000001] may indicates indices of four sub-bands, e.g., the first, third, fourth and tenth sub-band. The second indicator will have 4*32=128 bits. Therein, the first 32 bits may be associated with the first 32 RBs in the first sub-band, the second 32 bits associated with the 32 RBs in the third sub-band, the third 32 bits associated with the 32 RBs in the fourth sub-band and the last 32 bits may be associated with the 32 RBs in the tenth sub-band. The state bit-state, (e.g., “1” or “0”) of each bit in the second indicator may indicate and/or represents the state of an RB selected or not selected in the frequency-domain pattern. For example, the third bit of the second indicator may indicate the state of the third RB in the first sub-band. The 33^{rd} bit of the second indicator may indicate the state of the first RB in the third sub-band. The 64th bit of the second indicator may indicate the state of the last RB (e.g., the 32^{nd} RB) in the third sub-band. The 65th bit of the second indicator may indicate the state of the first RB in the fourth sub-band. The 97th bit of the second indicator may indicate the state of the first RB in the tenth sub-band. The last bit of the second indicator may indicate the state of the last RB in the tenth sub-band. The total overhead using the above proposed method for sparsity reporting may reduce the reporting overhead from 320 bits to 138 bits when 10 sub-bands, each with 32 RBs, is configured and/or when 4 sub-bands include RBs that are selected in the frequency-domain pattern. When each sub-band may include at least one RB in the selected frequency-domain pattern, the overhead of the proposed method is 330 bits.

Also disclosed herein are solutions for sparsity reporting. For example, the WTRU may send the above-mentioned, discussed, and/or proposed indicators to report the sparsity, e.g., the sparsity order of the wireless channel and/or the frequency-domain resources pattern in a separate, standalone, and/or new CSI report. The CSI report may include indications for reporting the sparsity order of the wireless channel and/or the frequency-domain pattern, wherein the CSI report may only have a single part. For example, the indicator(s) for indication of the determined sparsity order of the wireless channel and/or the frequency-domain pattern may not multiplex with other report quantities like the rank indicator (RI), the precoding matrix indicator (PMI), and/or the channel quality indicator (CQI) etc.

In another example, the WTRU may send the proposed indicators to report the sparsity, e.g., the sparsity order of the wireless channel and the time and/or frequency-domain resources pattern in a CSI report that may also include other report quantities, e.g., with RI, PMI, and/or CQI, etc. For example, the indicator(s) for indication of the determined sparsity order of the wireless channel and/or the frequency-domain pattern may multiplex with other report quantities like the RI, PMI, and/or CQI, etc.

In another solution, a WTRU may report the sparsity when one or more conditions are met. Such conditions may include that the WTRU is configured with periodic, semi-persistent, and/or aperiodic reporting of sparsity and its associated RS for measurement. The WTRU may be configured and/or indicated with one or more UL resources to use for the sparsity reporting. Such conditions may include when sparsity order changes from the latest reporting and/or the change is larger than a threshold, wherein the threshold is pre-configured, pre-determined, configured, and/or indicated to the WTRU. Such conditions may include when the sparsity order changes and its associated RS (e.g., preferred RS pattern and/or density) is different from current RS used, determined, and/or configured for data transmission (e.g., DM-RS or CSI-RS)

Also disclosed herein is determination of priority of sparsity inclusion in a CSI report. The network (e.g., gNB) allocates time and/or frequency-domain resources to the WTRU for reporting the UL control information (UCI). Due to limited available resources, the NR system may use and/or assigns different priority-levels to each element. The NR system may also report quantity in a CSI report that the WTRU uses to decide whether to report and/or transmit the CSI element or to drop the CSI element. The WTRU may drop the CSI element when not enough time and/or frequency resources are available for reporting the entire CSI report.

The WTRU may assign a priority level to the indicators used to indicate the sparsity of the wireless channel when the sparsity indicators are included in a CSI report that may also include other indicators, (e.g., for RI, PMI, and/or CQI, etc.).

The WTRU may assign a smaller priority level to the indicator(s) used to indicate the sparsity of the wireless channel as compared to the priority levels assigned to the indicator for reporting RI, PMI, and/or CQI, etc. The priority value to the sparsity indicators may be assigned using an equation, where the equation may include one or more variables associated with and/or intended for the sparsity reporting and/or sparsity indicators. The outcome of the equation or the value returned by the equation may provide the priority level for the sparsity-based indicators within a CSI report. For example, a CSI report may include an indicator for wideband CQI and an indicator for sparsity (P). The priority equation may be defined as Prio(U, P)=U+P, where U=0, and P=1. Based on this equation, the sub-band indicator has a priority zero and/or the sparsity indicator has a priority 1. Higher values of the equation may mean smaller priority and smaller value of the equation may mean higher priority. Based on the priority rule defined by the equation Prio(U, P)=U+P and/or the priority definition based on the priority value, the WTRU may report the CQI. The WTRU may drop the sparsity reporting when there are not sufficient resources for reporting both the wideband CQI and the sparsity of the channel.

When the WTRU may drop the sparsity reporting due to limited resources, the WTRU may perform and/or assume that the network (e.g., gNB) went back a fixed, previously configured, and/or previously reported time and/or frequency-domain pattern for transmission of the DMRS and/or CSI-RS. Moreover, the WTRU may receive a time and/or frequency-domain pattern for transmission of the follow-up CSI-RS and/or DMRS.

In another solution, the WTRU may assign a higher priority level to the indicator(s) used to indicate the sparsity of the wireless channel as compared to the priority levels assigned to the indicator for reporting other report quantities, e.g., RI, PMI, and/or CQI, etc. The priority value to the sparsity indicators may be assigned using an equation, where the equation may include one or more variables associated with and/or intended for the sparsity reporting or sparsity indicators. The outcome of the equation or the value returned by the equation may provide the priority level for the sparsity-based indicators within a CSI report. For example, a CSI report may include an indicator for wideband CQI and/or an indicator for sparsity (P). The priority equation may be defined as Prio(U, P)=(U, P), where U=0, and P=1. Based on the exemplary equation, the sub-band indicator has a priority zero and/or the sparsity indicator has a priority 1. Smaller values of the equation may mean smaller priority and/or higher value of the equation may mean higher priority. Based on the priority rule defined by the equation Prio(U, P)=(U, P) and/or the priority definition based on the priority value, the WTRU may drop the CQI. The WTRU may report the sparsity when there are not sufficient resources for reporting both the wideband CQI and/or the sparsity of the channel.

In another solution, the priority value to the sparsity indicator (e.g., to the indicator that indicates the frequency-domain pattern) may be assigned based on the determined sparsity order of the wireless channel. The priority value may be based on the sparsity order, the number of sub-bands, RBs, and/or subcarriers that are selected in the pattern. For example, the resources used by the gNB for transmission of DMRS and/or CSI-RS may depend on the number of selected resources in the pattern. The resources needed to transmit DMRS and/or CSI-RS may be smaller when the number of selected resources in the pattern is small. The resources needed to transmit DMRS and/or CSI-RS may be larger when the number of selected resources in the pattern is large. Therefore, the WTRU may assign a larger priority value to a CSI report carrying sparsity patterns and/or carrying indicators associated with sparsity patterns that has a smaller number of selected frequency-domain resources (e.g., RBs, sub-bands, and/or sub-carriers). The WTRU may assign a smaller priority value to a CSI report carrying sparsity patterns and/or carrying indicators associated with sparsity patterns that has a larger number of selected frequency-domain resources (e.g., RBs, sub-bands, and/or sub-carriers).

The priority value to the sparsity indicator may be determined based on the following equation:

$$Prio ( p ) = \frac{1}{{N}_{p}} ,$$

where Nₚ is the determined sparsity order of the wireless channel.

Also disclosed herein is a determination of a CSI report containing sparsity indications. In NR, the network (e.g., gNB) may trigger two or more CSI reports and/or assign UL resources for reporting the contents or elements of those CSI reports. Each CSI report may also be assigned a priority value used by the WTRU to prioritize the determination and/or reporting of one CSI report over another CSI report. The priority value may be needed when the resources for the two CSI reports overlap in at-least one time and/or frequency-domain resource unit (e.g., a subcarrier or a resource element (RE)). For instance, when the resources assigned to the WTRU for reporting of two CSI reports overlaps in at least one RE or one subcarrier, the WTRU may prioritize the determination and/or reporting of a first CSI report over the determination and reporting of a second CSI report.

The existing CSI report priority rule may be based on the following equation wherein the ith CSI report is assigned the following priority as provided in Equation 4:

$${Pri}_{iCSI} ( y , k , c , s ) = 2 {N}_{cells} {M}_{s} y + {N}_{cells} {M}_{s} K + {M}_{s} c + s \qquad ( Equation 4 )$$

Where y=0 for aperiodic CSI reports carried on a physical UL shared channel (PUSCH); y=1 for semi-persistent CSI reports may be carried on PUSCH; y=2 for semi-persistent CSI reports may be carried on a physical UL control channel (PUCCH); and y=3 for periodic CSI reports may be carried on PUCCH; k=0 for CSI reports carrying L1-RSRP or L1-SINR; k=0 for CSI reports not carrying L1-RSRP or L1-SINR; c is the serving cell index; N_{cells} is the number of cells; s is the report configuration identifier (ID); and Ms is the maximum number of CSI report configurations. An ith CSI report is said to have a higher priority as opposed to (ith+1) CSI report, if the computed priority value of the ith CSI report may be smaller than the priority value of the (ith+1) CSI report, (e.g., when Pri_{iCSI} (y, k, c, s) is smaller than Pri_{(i+1)CSI}(y, k, c, s)). A CSI report that contains indicators for sparsity indication and/or a CSI report that includes sparsity indicators along with indicators for other report quantities may need an assigned priority value. The priority value may prioritize or de-prioritize a CSI report containing sparsity indications over other CSI reports.

To determine priority value in such circumstances, the WTRU may assign a priority value to a CSI report that includes indicators for sparsity indication based on the determined sparsity order, where a higher priority is assigned to the CSI report when the sparsity order (Nₚ) is small and a smaller priority is assigned to the CSI report when the sparsity order is large.

Equation 4 may be modified to assign priority value to a CSI report that includes indications for reporting the sparsity order and the frequency-domain pattern as provided in Equation 5:

$${Pri}_{iCSI} ( y , k , c , s , {n}_{p} ) = 2 {N}_{cells} {M}_{s} y + {N}_{cells} {M}_{s} K + {M}_{s} c + s - \frac{1}{{N}_{p}} \qquad ( Equation 5 )$$

Where Nₚ is the determined sparsity order of the wireless channel. In another solution, the values of the variables in Equation 2 may be modified to assign priority values to a CSI report that includes indication(s) for sparsity reporting. For example, y=−4 for aperiodic CSI report may include sparsity indications and is supposed to be carried on PUSCH; y=−3 for semi-persistent CSI reports may include sparsity indications and is supposed to be carried on PUSCH; y=−2 for semi-persistent CSI reports may include sparsity indications and is supposed to be carried on PUCCH; y=−1 for periodic CSI reports may include sparsity indications and is supposed to be carried on PUCCH.

Also disclosed herein are indications of a WTRU initiating sparsity reporting. The WTRU may have better knowledge of the wireless channel as compared to the network (e.g., gNB) as the CSI reported by the WTRU to the network (e.g., gNB) is a quantized variant of the actual CSI measured by the WTRU. Therefore, since the WTRU has greater knowledge of the channel, the WTRU may initiate and/or recommend to the network (e.g., gNB) to trigger sparsity reporting.

The WTRU may track, keep track of, observe, and/or monitor at least one of the following channel parameter(s) for initiating sparsity reporting: a maximum and/or a minimum delay spread; a number of delay spread values greater than a threshold, where the threshold may be configured by the network (e.g., gNB) (by RRC, MAC-CE, and/or DCI) or the threshold may be defined as a fixed value based on a channel type, number of physical antennas, and/or number of logical antenna ports etc.; and/or a number of channel coefficients, channel amplitudes, and/or channel gain values greater than a configured and/or a fixed threshold.

The WTRU may keep track and/or periodically measure one or more of the above-mentioned wireless channel properties by measuring a RS. For example, The WTRU may measure a RS to keep track, determine, and/or measure one or more of the properties discussed above that changing in time and/or frequency over the wireless channel. At least one of the following RSs may be used: a periodic RS; a semi-persistent RS; an aperiodic RS; a tracking RS; and/or a demodulation RS.

The WTRU may initiate sparsity reporting using a first indicator in a CSI report based on the measurements, calculations, and/or determinations of the maximum delay spread, minimum delay spread, a number of delay spread values greater than a threshold, and/or a number of channel coefficients greater than a gNB configured or fixed threshold, upon measuring the RSs. A CSI report may include a first indicator where the first indicator may be a single bit indicator. The state value of the single bit indicator may be “1” when the WTRU wants the network (e.g., gNB) to initiate sparsity reporting and/or trigger resources for measurement and/or reporting of the channel sparsity. The state value of the single bit indicator may be “0” when the WTRU does not want the network (e.g., gNB) to initiate sparsity reporting and/or not trigger resources for measurement and/or reporting of the channel sparsity. The first indicator may be placed in a part, portion, and/or section of a CSI report (e.g., if the CSI report has multiple parts, portions or sections) that has the highest transmission priority (e.g., in-terms of CSI inclusion and/or CSI reporting) priority. In response to the first indicator, the WTRU may receive a DCI from the network (e.g., gNB). The DCI may include indications for triggering the first RS for measuring sparsity of the wireless channel and/or resources for reporting sparsity of the wireless channel.

In another solution, the WTRU may initiate sparsity reporting using a first indicator and a second indicator in a CSI report. The first indicator may indicate the absence of presence of a second indicator in the CSI report. The second indicator may indicate the sparsity of the wireless channel, e.g., the sparsity order and/or frequency-domain pattern.

WTRU reporting on the second (DL) RS may be based on the determined sparsity order. In a solution, a WTRU may be configured with a DL RS (e.g., CSI-RS) resource, where the DL RS resource is associated with multiple candidate parameter sets, each comprising different time, frequency, and/or spatial domain (e.g., TCI-state(s), beam reference, beam RS, etc.) parameter(s). For example, the DL RS resource may be configured with a first candidate parameter set and a second candidate parameter set. The first candidate parameter set may indicate a first frequency (and/or time) domain pattern of allocated RE(s) for transmission of the DL RS resource. The second candidate parameter set may indicate a second frequency (and/or time) domain pattern of allocated RE(s) for transmission of the DL RS resource. In an example, the first candidate parameter set may be applied (as a default) when the DL RS resource is configured.

The WTRU may perform at least one behavior related to sparsity measurement discussed herein. Based on performing the sparsity-related measurement, the WTRU may determine which candidate parameter set is preferred (e.g., based on comparison with one or more thresholds for sparsity) for the configured DL RS resource (e.g., mentioned as the second DL RS above, after performing the sparsity-related measurement based on the first DL RS above). For example, instead of the first candidate parameter set (which is initially used), the WTRU may determine the second candidate parameter set (e.g., sparser than the first set) is preferred. The WTRU may further determine that the second parameter set may be reported, when the sparsity level (e.g., a determined sparsity order) is, e.g., below a threshold.

Based on the determination, the WTRU may report the determined preferred candidate parameter set (e.g., the second set) along with the DL RS resource ID (as the second DL RS), The WTRU may also report a value representing the sparsity and/or the sparsity order. The WTRU may receive a confirmation message (e.g., signal and/or command) of the candidate parameter set change and/or update for the DL RS resource, e.g., with a time-domain offset parameter indicating when the parameter set change begins to apply. On condition that the WTRU does not receive the confirmation message, within a parameter (e.g., a configured and/or indicated time window), the WTRU may maintain the current candidate parameter set (e.g., the first set). Moreover, the WTRU may not apply the reported second candidate parameter set. This may provide benefits. Specifically, the DL RS resource transmission overhead may be saved based on WTRU's reported parameter set (e.g., based on the sparsity measurement). The network among which the WTRU selects for the reporting may control the candidate patterns for the DL RS resource.

The WTRU may receive an indication and/or configuration on whether a measurement restriction applies when a candidate parameter set is changed. For example, the WTRU may apply a type of measurement averaging even though the candidate parameter set is changed (e.g., configured by the network). In the applied type of measurement averaging, the WTRU may combine (e.g., perform averaging, perform a weighted averaging, and/or perform combining based on a function and/or rule) a first set of measurements based on the first parameter set and (after the parameter set change) a second set of measurements based on the second parameter set, of the (same) DL RS resource. The WTRU may then derive reporting content(s), e.g., RI, PMI, CQI, CSI resource indicator (CRI), SSBRI, (L1-)RSRP, and/or (L1-)SINR, etc. For example, the WTRU may apply measurement restriction (e.g., 1-shot measurement restriction, multi-shot measurement restriction, and/or measurement averaging window resetting) when the candidate parameter set is changed (e.g., configured by the network). The WTRU may determine to report the second set of measurements based on the second parameter set (without averaging with the first set of measurements), of the (same) DL RS resource. The WTRU may then derive reporting content(s), e.g., RI, PMI, CQI, CRI, synchronization signal/physical broadcast channel block resource indicator (SSBRI), (L1-)RSRP, and/or (L1-)SINR, etc., after the parameter set change.

Based on the WTRU measurements of a first received DL RS, the WTRU may determine the sparsity order, and/or may feed back the determined sparsity order to the network. Before determining the sparsity order from the first DL RS, the network may have configured DL RSs (e.g., DMRS, CSI-RS, and/or PTRS) and/or UL RSs (e.g., DMRS and/or SRS) according to a frequency-domain pattern that is not optimized to the sparsity order.

A WTRU may receive a DL RS with a time and/or frequency-domain configuration as a function of the sparsity order. In a solution, the WTRU may receive a RS configuration with a time and/or frequency-domain sparsity pattern as a function of the sparsity order. For example, the WTRU may be configured with a RS with a primary frequency-domain sparsity pattern of resource elements to process. The RS may be configured with a secondary sparsity pattern of frequency-domain resource elements to monitor where the secondary pattern indicates a subset of resource elements from the primary pattern to monitor. The secondary pattern may be associated to the sparsity order and the WTRU may be configured with multiple sparsity patterns where each one is associated to a different sparsity order. For example, the primary frequency-domain pattern is associated to all the REs in the measurement bandwidth (e.g., a BWP, a sub-band, and/or an RB). These REs may be indexed from 1:N_RE. The secondary frequency-domain pattern may be configured as a length N_RE bitmap. The WTRU may determine that each bit that is toggled on (e.g., “1”) may indicate the RE index to monitor. Each bit that is toggled off (e.g., “0”) may indicate the RE index that is not monitored. The number of toggled bits in the N_RE bitmap may be less than or equal to N_RE. The WTRU may receive the RS over the REs that are associated to the toggled-on bit. Each sparsity pattern may be associated with a pilot sequence and/or measurement matrix for processing, (e.g., using compressive sensing transmitted on the subset of RE indices). Additionally or alternatively, the secondary pattern may be defined as a list of RE indices to monitor.

The WTRU may receive an RRC configured sparsity pattern that applies for one or more RSs, and the network may reconfigure the pattern (e.g., MAC-CE) as a function of the determined sparsity order (e.g., WTRU feedback). The configuration may include an association between each sparsity pattern and each RS. Multiple sparsity patterns may be associated to the same RS and the network may activate only one. Additionally or alternatively, each sparsity pattern may be dynamically indicated through an aperiodic request (e.g., DCI). The aperiodic request may include the secondary pattern index to activate. For example, each secondary pattern index may be associated to the aperiodic trigger request ID. If a WTRU receives a DCI triggering an aperiodic CSI-RS and/or CSI report, the WTRU may determine the secondary pattern as a function of the DCI.

In a solution, a WTRU may be configured, indicated, and/or fixed with a number of base patterns for allocation of RSs in frequency and/or time. Each pattern may be associated with an index. Then, based on a reported and/or determined sparsity order, a WTRU may be indicated with one or more indices. Herein, the WTRU may determine the pattern by aggregating the patterns associated to the indicated patterns.

In another solution, a sparsity order may be associated to one or multiple sparsity patterns. The WTRU may determine the REs to monitor based on applying the one or multiple sparsity patterns per RS. Different basic sparsity patterns may be defined for the highest configured sparsity order on non-overlapping REs. For example, for sparsity order N1, multiple sparsity patterns may be defined over a set of REs (e.g. sparsity pattern 1 and/or sparsity pattern 2). For a different sparsity order N2, the WTRU may be configured with an aggregation of the sparsity patterns from N1. For example, for sparsity order N1, the WTRU may assume transmission and/or reception of a RS based on pattern 1. For sparsity order N2, the WTRU may assume transmission and/or reception of a RS based on the aggregated of patterns 1 and/or 2 where both patterns are applied to the same RS. The network (e.g., gNB) may transmit the RS sequence for N1 over the REs of sparsity pattern 1, and for N2 over the REs of sparsity pattern 1, and/or sparsity pattern 2. With multiple WTRUs, the same set of basic sparsity patterns (e.g., sparsity patterns 1, 2, 3, and 4) may be configured commonly. Therein, the association to the sparsity order may be WTRU-specifically configured. For example, for sparsity order N1, WTRU1 may monitor sparsity pattern 1, and/or WTRU2 may monitor sparsity pattern 2. For sparsity order N2, WTRU1 may monitor sparsity pattern 1 and 3, and/or WTRU2 may monitor sparsity patterns 2 and 4.

In another solution, a WTRU may be configured with a primary sparsity pattern associated to a sparsity order and/or with a sparsity parameter. The sparsity parameter may determine a secondary sparsity pattern as a function of the primary sparsity pattern. For example, the sparsity parameter may be a phase shift. The phase shift may be equivalent to a shift and/or rotation of the primary sparsity pattern. The primary sparsity pattern may indicate that the REs are toggled on for monitoring. The primary pattern may indicate to monitor the nth RE, (e.g., RE(n)). The secondary pattern may indicate a shift of N_shift with respect to the primary pattern. The WTRU may determine that the secondary pattern indicates to monitor RE(n+N_shift) mod N_RE. Therein, mod N_RE may indicate that the shift and/or rotation of the pattern is cyclical. The WTRU may further determine that the shift and/or rotation of the pattern may wrap back to the beginning of the allocated bandwidth. The shift in frequency-domain (e.g., number of REs) may be equivalent to a time-domain shifting of the sequence.

In another solution, the primary sparsity pattern may be indicated commonly by the network for multiple WTRUs (e.g., WTRUs which report the same sparsity order are configured with the same primary sparsity pattern). The secondary sparsity pattern (e.g., RE subsets and/or phase shifts) may be indicated based on a WTRU-specific manner. For example, WTRU1 and/or WTRU2 report the same sparsity order. Both WTRU1 and WTRU2 may be configured with the same primary sparsity pattern. WTRU1 may receive the secondary sparsity pattern associated to N_shift1. WTRU2 may receive the secondary sparsity pattern associated to N_shift2. WTRU1 may monitor the REs of the secondary sparsity pattern on REs associated to N_shift1. WTRU2 may monitor the REs of the secondary sparsity pattern on REs associated to N_shift2.

In another solution, the secondary sparsity pattern may be configured with the same number and/or location of the REs as the primary sparsity pattern. Each WTRU may be configured with a different scrambling sequence/ID. Each WTRU may perform channel estimation on the same set of REs from the primary sequence. Each WTRU may determine its own channel based on the WTRU-specifically configured scrambling.

A WTRU may receive DL RSs with a pattern configuration associated to the sparsity order. In a solution, the WTRU may receive a configuration for a RS associated to a sparsity order. Resource settings may be configured per RS resource or per RS resource set (e.g., for all resources in the resource set). Each setting may be associated to a time and/or frequency-domain pattern configuration (e.g., one of the patterns described previously). For example, a WTRU may be configured with multiple RS resource sets. Each resource set may be associated to a sparsity order. Additionally or alternatively, each RS resource may be associated to a sparsity order. The network may reconfigure the RSs at the WTRU as a function of the determined sparsity order.

Additionally or alternatively, each RS resource set index and/or each RS resource index may be configured with two different RS settings where each setting is associated to a sparsity order. The WTRU may receive a sparsity order. The WTRU may determine which RS to monitor as a function of the activated sparsity order. For example, the WTRU may be configured with RS1(Config={Sparsity1, Sparsity2}) where Sparsity1 and Sparsity2 represent two different sparsity orders, and Config represents the time and/or frequency-domain resource configuration. The WTRU may determine different time and/or frequency densities based on the configured sparsity order. If the sparsity order is Sparsity1, the network may configure the WTRU with RS1 (Config=Sparsity1), and with RS2 (Config=Sparsity2) if the sparsity order is Sparsity2.

The WTRU may report a CSI associated to a sparsity order. The CSI reporting setting may be associated with multiple RS resource sets or multiple RS resources where each RS resource set or RS is associated to a sparsity order. A WTRU may receive an activation command (e.g., a MAC-CE and/or an aperiodic CSI request in a DCI) to activate and/or deactivate the resource sets and/or resources associated to the indicated sparsity order. The network (e.g., gNB) may determine to send the activation command based on the WTRU's feedback on a first RS resource set or RS resource. The WTRU may transmit CSI feedback where the WTRU determines the CSI based on the activated RS for the determined sparsity order.

Additionally or alternatively, multiple RS resource sets and/or multiple RS resources may be configured in a CSI reporting setting. Each RS resource set and/or resource may be associated to a sparsity order, and one or a subset of the multiple resources is activated. The WTRU may perform CSI measurement for each of the RS resource sets and/or RS resources. The WTRU may determine multiple CSIs (e.g., CRI, LI, RI, PMI, and/or CQI, etc.) where each CSI is associated to a RS and, therefore, to a sparsity order. The CSI reporting may be configured with a RS restriction where the WTRU is configured to report one or multiple CSIs for different sparsity orders. For example, the WTRU may be configured with RS1 for sparsity order 1, and/or RS2 for sparsity order 2. The WTRU may receive RS1 and/or RS2 and determine CSI1 and/or CSI2 for sparsity order 1 and/or 2, respectively. The reporting configuration may indicate to report CSI for both sparsity levels, and the WTRU may include both CSIs in the CSI report. Additionally or alternatively, the reporting configuration may indicate that the WTRU determines which CSIs to report. For example, the WTRU may measure CSI1 and/or CSI2 and determines to report only CSI1. The WTRU may include the index of RS1 (e.g., of sparsity order 1) and CSI1 associated to RS1. The WTRU may also determine to report both CSI1 and CSI2. Therefore, the WTRU may include in the CSI report the index of RS1 and RS2 and/or associated CSIs.

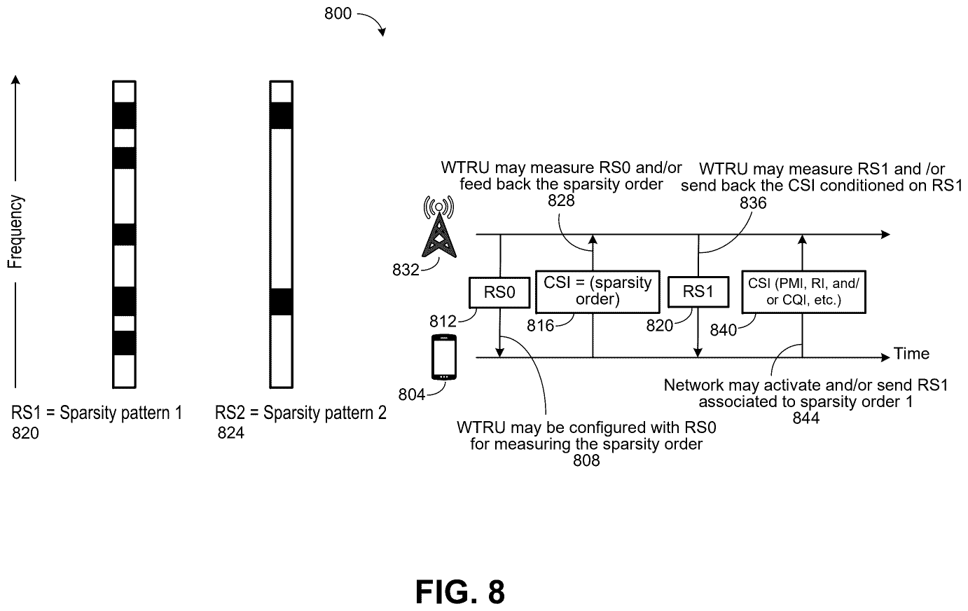

FIG. 8 depicts a diagram 800 of a wireless transmit/receive unit (WTRU) 804 that reports a channel state information (CSI) associated to a sparsity order. At 808, FIG. 8 depicts a procedure wherein the WTRU 804 is configured with a first RS0 812 for measuring the sparsity order 816 and/or different sparsity patterns 1 and 2 associated to RS1 820 and RS2 824, respectively. The WTRU 804 may determine the sparsity order from RS0 812. At 828, the WTRU 804 may feed the sparsity order 816 back to the network 832. The network 832 may activate one of the sparsity patterns. At 836, the network 832 may transmit the RS associated to the sparsity pattern. The WTRU 804 may determine a CSI 840 based on the sparsity pattern. At 844, the WTRU may transmit the CSI 840 on a feedback resource. In this example, only one RS1 820 is activated by the network. However, both RS1 820 and RS2 824 may be activated (e.g., transmitted). The WTRU 804 may determine which CSIs to include in the CSI report.

Additionally or alternatively, CSI reporting configurations (e.g., sub-band size and/or CSI reporting quantities) may be determined based on sparsity order of the associated RS. For example, a WTRU may determine CSI reporting configuration based on sparsity order of the RS used for the CSI reporting. One or more of following CSI reporting configuration may be determined based on the sparsity order: sub-band size of CSI reporting quantity (e.g., CQI and/or PMI); codebook type for PMI (e.g., Type-I and/or Type-II); Set of CSI reporting (e.g., CRI, LI, RI, PMI, and/or CQI); CSI reporting timeline (e.g., periodicity and/or activation/deactivation); and/or CSI reporting container (e.g., PUSCH, PUCCH, and/or a physical random access channel (PRACH), etc.).

What is claimed is:

1. A wireless transmit/receive unit (WTRU) comprising:
a processor configured to:
receive first configuration information, wherein the first configuration information indicates a first downlink reference signal (RS), and wherein the first configuration information indicates one or more parameters, the one or more parameters comprising information indicating a minimum channel impulse response (CIR) duration, a maximum CIR duration, an amplitude threshold, one or more frequency-domain patterns, or one or more time-domain patterns;
receive downlink control information (DCI), wherein the DCI comprises triggering information that directs the WTRU to perform measurements and report a sparsity order of a channel associated with the downlink RS;
determine the sparsity order of the channel associated with the downlink RS based on the one or more parameters; and
send a report, wherein the report comprises one or more of an indication of the sparsity order, an indication of a preferred frequency-domain pattern indicating RSs according to the sparsity order, or spatial information associated with the sparsity order.

2. The WTRU of claim 1, wherein the processor is configured to determine the sparsity order as an estimate of a number of non-zero CIR coefficients associated with the first downlink RS within a predefined time duration.

3. The WTRU of claim 1, wherein the processor is configured to determine the sparsity order based on a subset of delay paths, wherein the subset of delay paths is within the minimum CIR duration or the maximum CIR duration, and wherein the subset of delay paths exceed the amplitude threshold.

4. The WTRU of claim 1, wherein the one or more parameters further comprises one or more frequency-domain patterns or time-domain patterns, wherein each frequency-domain pattern or time-domain pattern is associated with a different sparsity order.

5. The WTRU of claim 1, wherein the report further comprises information indicating a time-domain pattern that indicates a delay profile of the channel and comprises a bitmap associated with the time-domain pattern, wherein the bitmap comprises one or more bits of a first value that are associated with a CIR coefficient that has met a preconfigured threshold.

6. The WTRU of claim 1, wherein the indication for the preferred frequency-domain pattern further comprises a location of each resource element or subcarrier that carries the first downlink RS.

7. The WTRU of claim 6, wherein the indication for the preferred frequency-domain pattern is based on a bitmap or an index to one or more other frequency-domain patterns.

8. The WTRU of claim 1, wherein the DCI indicates one or more uplink resources, and the processor is configured to send the report via the uplink resources identified by the DCI.

9. The WTRU of claim 8, wherein the processor is configured to:
receive second configuration information, wherein the second configuration information indicates a second downlink RS, wherein the second downlink RS is based on the sparsity order;
receive one or more of an indication for a frequency-domain pattern for second downlink RS placement or a rotation parameter of the frequency-domain pattern; and
determine a frequency-domain pattern for the second downlink RS based on one or more of the indications for frequency-domain pattern for second downlink RS placement or the rotation parameter of the frequency-domain pattern.

10. The WTRU of claim 9, wherein the indication for a frequency-domain pattern for second downlink RS placement comprises a bitmap, wherein the bitmap has a length equal to or less than the maximum number of possible RS locations.

11. A method implemented by a wireless transmit/receive unit (WTRU), the method comprising:
receiving first configuration information, wherein the first configuration information indicates a first downlink reference signal (RS), and wherein the first configuration information indicates one or more parameters, the one or more parameters comprising information indicating a minimum channel impulse response (CIR) duration, a maximum CIR duration, an amplitude threshold, one or more frequency-domain patterns, or one or more time-domain patterns;
receiving downlink control information (DCI), wherein the DCI comprises triggering information that directs the WTRU to perform measurement and reporting of a sparsity order of a channel associated with the downlink RS;
determining the sparsity order of the channel associated with the downlink RS based on the one or more parameters; and
sending a report, wherein the report comprises one or more of an indication of the sparsity order, an indication of a preferred frequency-domain pattern indicating RSs according to the sparsity order, or spatial information associated with the sparsity order.

12. The method of claim 11, the method further comprising determining the sparsity order as an estimate of a number of non-zero CIR coefficients associated with the first downlink RS within a predefined time duration.

13. The method of claim 11, the method further comprising determining the sparsity order based on a subset of delay paths, wherein the subset of delay paths is within the minimum CIR duration or the maximum CIR duration, and wherein the subset of delay paths exceed the amplitude threshold.

14. The method of claim 11, wherein the one or more parameters further comprises one or more frequency-domain patterns or time-domain patterns, wherein each frequency-domain pattern or time-domain pattern is associated with a different sparsity order.

15. The method of claim 11, wherein the report further comprises information indicating a time-domain pattern that indicates a delay profile of the channel and comprises a bitmap associated with the time-domain pattern, wherein the bitmap comprises one or more bits of a first value that are associated with a CIR coefficient that has met a preconfigured threshold.

16. The method of claim 11, wherein the indication for the preferred frequency-domain pattern further comprises a location of each resource element or subcarrier that carries the first downlink RS.

17. The method of claim 16, wherein the indication for the preferred frequency-domain pattern is based on a bitmap or an index to one or more other frequency-domain patterns.

18. The method of claim 11, wherein the DCI indicates one or more uplink resources, and the processor is configured to send the report via the uplink resources identified by the DCI.

19. The method of claim 18, the method further comprising:
receiving second configuration information, wherein the second configuration information indicates a second downlink RS, wherein the second downlink RS is based on the sparsity order;
receiving one or more of an indication for a frequency-domain pattern for second downlink RS placement or a rotation parameter of the frequency-domain pattern; and
determining a frequency-domain pattern for the second downlink RS based on one or more of the indications for frequency-domain pattern for second downlink RS placement or the rotation parameter of the frequency-domain pattern.

20. The method of claim 19, wherein the indication for a frequency-domain pattern for second downlink RS placement comprises a bitmap, wherein the bitmap has length equal to or less than the maximum number of possible RS locations.
